(19) United States
(12) Patent Application Publication
(10) Pub. No.: US 2014/0215050 A1
(43) Pub. Date: Jul. 31, 2014

(54) METHOD AND SYSTEM FOR WEB ANALYTICS USING A PROXY

(71) Applicant: Lawrence T. Lu, San Jose, CA (US)

(72) Inventor: Lawrence T. Lu, San Jose, CA (US)

(73) Assignee: Array Networks, Inc., Milpitas, CA (US)

(21) Appl. No.: 13/753,062

(22) Filed: Jan. 29, 2013

(51) Int. Cl. H04L 12/26

(52) U.S. Cl. CPC H04L 43/00
USPC 709/224

(57) ABSTRACT

A method for tracking visits to a web page using a proxy is disclosed, which includes receiving a request from a web browser on a proxy for a web page hosted on a web server; sending the request for the web page from the proxy to the web server; receiving the web page from the web server on the proxy; inserting one or more web page tags into the web page to generate a modified web page, wherein the one or more web page tags generate data about traffic to the web page; forwarding the modified web page to the web browser with the one or more web page tags embedded therein; executing the one or more web page tags within the modified web page; and sending data from the executed one or more web page tags a data collection system.

### FIELD OF THE INVENTION

The present invention relates to a method and system for web analytics using a proxy, and more particularly, to a method and system for web analytics using a proxy, which inserts tag(s) (mostly Javascript) into web (mostly HTML) pages, which are requested from a web server and received by a web browser from the proxy.

### BACKGROUND

Web analytics is often described as the measurement, collection, analysis and reporting of internet data for purposes of understanding and optimizing web usage from accountability and accounting aspect. Web analytics provides information about the number of visitors to a website and the number of page views, and can help gauge traffic and popularity trends which can be useful for example, for market research. In addition, the use of web analytics can be used as a tool for business and market research including improving the effectiveness of a website.

Web analytics can be divided into two categories, off-site and on-site web analytics. Off-site web analytics refers to the measurement and analysis of website and/or webpage regardless of whether an individual or company owns and/or maintain a website or web page. Off-site web analytics includes the measurement of a website's potential audience or opportunity, visibility, and comments on the Internet as a whole.

Generally, on-site web analytics measure a visitor's behavior once on a visitor is on a website. For example, a website can be comprised of one or more web pages, which are linked together through an icon on the web page. The icons lead the user to other web pages either within the website or alternatively, the icon can be what is known as a click through, which can lead to another website.

On-site web analytics measures the performance of a website in a commercial context. The data obtained from the website is typically compared against key performance indicators for performance, and can be used to improve a website or marketing campaign's audience response. Google Analytics®, for example is the most widely-used on-site web analytics service.

The two main technical ways of collecting the data from the website for on-site web analytics includes server log file analysis, which reads the log files in which the web server records file requests by browsers, and page tagging, which uses JavaScript embedded in the site page code to make image requests to a third-party analytics-dedicated server whenever a page is rendered by a web browser or, if desired, when a mouse click occurs. The two methods collect data that can be processed to produce reports on web traffic for a website and/or a web page. In addition, other data sources may be added to augment the website behavior data described above. For example, e-mail open and click-through rates, direct mail campaign data, sales and lead history, or other data types as needed.

The advantages of page tagging over log file analysis can include counting is activated by opening the page given that the web client runs the tag scripts, rather than requesting it from the server. For example, if a page is cached, it will not be counted by the server. Cached pages can account for up to one-third of all page views. In addition, not counting cached pages seriously skews many site metrics. It is for this reason server-based log analysis is not considered suitable for analysis of human activity on websites.

Data is gathered via a component (or “tag”) in the web page, usually written in JavaScript, although Java and Flash can be used. JQuery and AJAX can also be used in conjunction with a server-side scripting language (such as PHP) to manipulate and (usually) store it in a database, basically enabling complete control over how the data is represented. The script may have access to additional information on the web client or on the user, not sent in the query, for example, the price of the goods they purchased. Page tagging can also report on events which do not involve a request to the web server, such as interactions within Flash movies, partial form completion, mouse events such as onClick, onMouseOver, onFocus, onBlur etc. The page tagging service manages the process of assigning cookies to visitors, and with logfile analysis, the server has to be configured to do this. Page tagging can also be available to companies who do not have access to their own web servers.

Page tags can be manually inserted into the website or webpage into a footer of the webpage. The page tags can also include plug-ins, modules, and tag management devices such as Tagman®, Tealium®, etc. However, the use of website tagging is becoming hard to manage due to increasing complexity in obtaining meaningful and accurate results and associated performance challenges. For example, in order to obtain meaningful and accurate results, page tagging can require information technology (IT) expertise to implement the page tags into the websites.

In addition, to web page management, many industries and enterprises are looking to simplify and optimize their business operations by increasing employee productivity and business agility while streamlining network management and delivering dramatic cost savings. In order to provide a secure, on-demand access both internally and remotely, and/or application delivery controllers are available, which connect employees with remote applications and information (i.e., resources/services). These secure controllers and devices are design to meet the demands of customers, from small, local businesses to large, global enterprises and from financial services and healthcare to government and education. For example, secure access to applications and web-enabled content can be utilized by almost all types of businesses from delivering fast, secure access to administrative and clinical applications and patient records in the healthcare industry, improving customer serving service and services while reducing costs for a financial institution, generating optimum productivity from supply chains and employees for retailers, enabling fast, secure access to administrative and educational applications; providing fast access and iron-clad security for vital operations and data for governmental entities. In addition, the ability to offer fast and secure access and e-mail services, optimum availability and security with streamlined management over the internet is also desirable.

### SUMMARY OF THE INVENTION

In consideration of the above issues, it would be desirable to have a system and method, which provides web analytics using a proxy, which inserts tag(s) into web page request by a web browser.

In accordance with an embodiment, a method for tracking visits to a web page using a proxy is disclosed, comprising: receiving a request from a web browser on a proxy for a web page hosted on a web server; sending the request for the web page from the proxy to the web server; receiving the web page from the web server on the proxy; inserting one or more web page tags into the web page to generate a modified web page, wherein the one or more web page tags generate data about traffic to the web page; forwarding the modified web page to the web browser with the one or more web page tags embedded therein; executing the one or more web page tags within the modified web page; and sending data from the executed one or more web page tags a data collection system.

In accordance with another embodiment, a system for tracking visits to a web page hosted by a web server is disclosed, comprising: a proxy configured to: receive a request from a web browser for a web page hosted on a web server; send the request for the web page to the web server; receive the web page from the web server; insert one or more web page tags into the web page to generate a modified web page, wherein the one or more web page tags generate data about traffic to the web page; forward the modified web page to the web browser with the one or more web page tags embedded therein; and send data from execution of one or more web page tags by the web browser to a data collection system.

In accordance with a further embodiment, a non-transitory computer-readable storage medium comprising computer-executable instructions that, in response to execution, cause a computing system to perform operations for tracking visits to a web page using a proxy is disclosed, comprising: receiving a request from a web browser on a proxy for a web page hosted on a web server; sending the request for the web page from the proxy to the web server; receiving the web page from the web server on the proxy; inserting one or more web page tags into the web page to generate a modified web page, wherein the one or more web page tags generate data about traffic to the web page; forwarding the modified web page to the web browser with the one or more web page tags embedded therein; executing the one or more web page tags within the modified web page; and sending data from the executed one or more web page tags a data collection system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a network system, which includes a client or client device, a proxy, and a server in accordance with an exemplary embodiment

FIG. 2 is an illustration of a network system for web analytics in accordance with an exemplary embodiment.

FIG. 3 is an illustration of a network system for web analytics in accordance with a further exemplary embodiment.

FIG. 4 is an illustration of a network system for web analytics in accordance with another exemplary embodiment.

### DESCRIPTION OF THE PREFERRED EMBODIMENTS

Reference will now be made in detail to the embodiments of the invention, examples of which are illustrated in the accompanying drawings. Wherever possible, the same reference numbers are used in the drawings and the description to refer to the same or like parts.

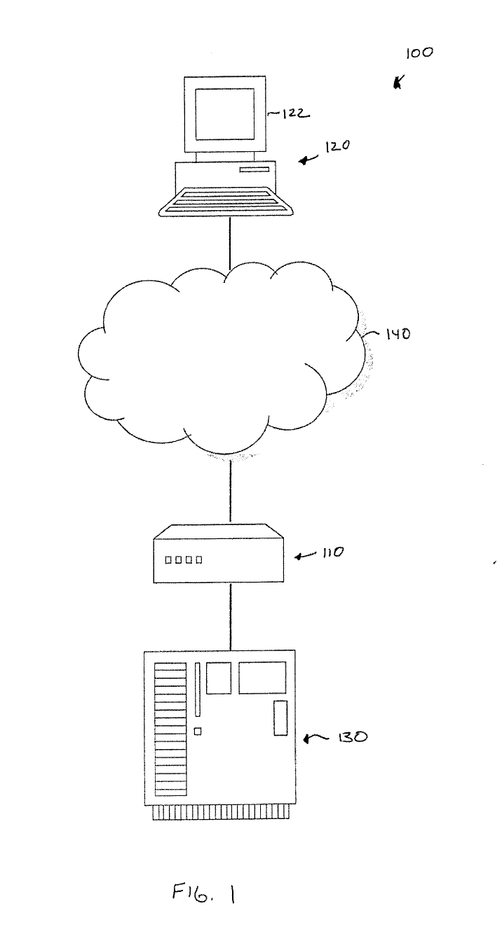

FIG. 1 shows a schematic diagram of a network system 100, which includes a networking device or proxy 110, a remote user (i.e., client or client device) 120, and one or more web servers 130. As shown in FIG. 1, the networking device 110 provides network access to one or more web servers 130, which host a plurality of web services (not shown) via the Internet 140. As shown in FIG. 1, the networking device or proxy 110 can includes hardware components (or hardware), software components (software), and an operating system. The hardware components or physical part of the device 110, typically include the digital circuitry, as distinguished from the computer software or software components that execute within the hardware. The hardware preferably includes at least one application server, a web server, a network access server (NAS) and/or card (network interface card or Ethernet interface card) used by the Internet service provider (ISP) for the remote user and/or client 120 for access, and a network and policy management device. For example, in accordance with an exemplary embodiment, the client is a personal computer 122. It can be appreciated that the networking device or proxy 110 also preferably includes at least one proxy server.

The networking device 110 also includes an operating system (i.e., software component) having a kernel, which is responsible for the communication between hardware and software components. The kernel provides abstraction layers for the hardware components, especially for memory, processors and communication between hardware and software. In addition, the kernel can also provide software facilities to userland applications such as process abstractions, interprocess communication and system calls. As shown in FIG. 1, the software components can include application software, including web-based applications, a file access module, a client/server application manager, a thin client support and a Layer 3 VPN, and an application acceleration module, including a hardware-based SSL accelerator and hardware compression module. In addition, each remote user or client 120 includes software for connecting the client 120 to the networking device 110.

It can be appreciated that the networking proxy device 110 can be an application delivery controller, an HTTP appliance, a TCP appliance, a web server, a web proxy, and/or a load balancer. In accordance with an exemplary embodiment, the one or more web servers 130 can host a plurality of web services. The plurality of web services can includes websites, which host one or more web pages, and/or web-enabled applications. For example, the web-enabled applications can be configured to help integrate company systems so they share information and connect employees, suppliers, and administrators to automated business processes.

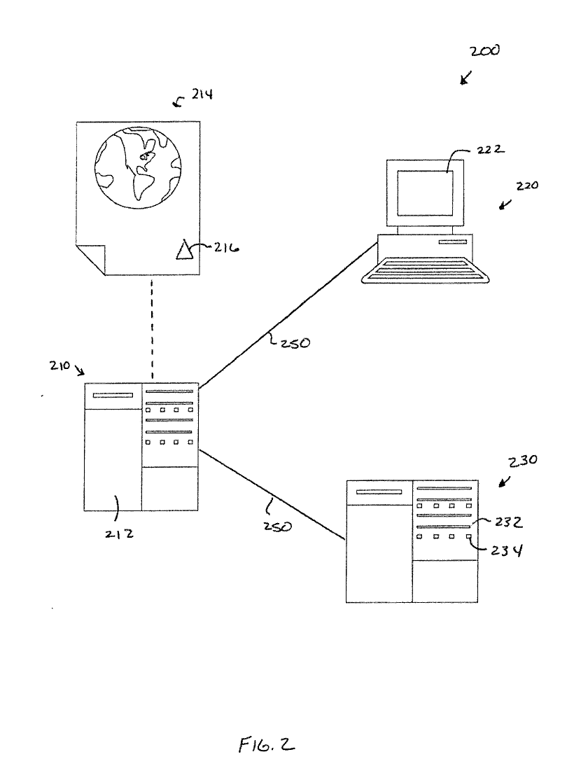

FIG. 2 is an illustration of a network system 200 for web analytics in accordance with an exemplary embodiment. As shown in FIG. 2, the network system 200 for web analytics includes a web server 210, which hosts one or more websites 212. The web server 210 and the one or more websites and/or web pages 212 can be accessible through a web browser 222 having an internet address (e.g., 175.1.5.17), and which is displayed on a monitor or mobile device 220. In accordance with an exemplary embodiment, for example, the communication of data or communication protocol between the one or more websites 212 can include HTTP and HTTPS.

In accordance with an embodiment, the information within the web pages 212 can be in an HTML or XHTML format, and can provide navigation to other web pages via hypertext links. In addition, website 212 can subsume other resources such as style sheets, scripts and images into their final presentation. In accordance with an embodiment, each of the one or more websites 212 includes one or more web pages 214. Each of the one or more web pages 214 can includes a component or page tag 216.

In accordance with an exemplary embodiment, the component (or page tag) 216 is a JavaScript embedded in the website page code to make image requests to a data collection server 230 having a web analytic system 232. In accordance with an exemplary embodiment, whenever a web page 214 is rendered by a web browser 222 or, if desired, when a mouse click occurs. In accordance with an exemplary embodiment, data collected 234 is processed by the data collection server 230 into one or more web traffic reports. In addition, other data sources may be added to augment the website behavior data. For example, e-mail open and click-through rates, direct mail campaign data, sales and lead history, or other data types can be collected and reproduced in one or more reports.

The data collection server 230 can be in the form of an on-site web analytic system 232, which measure a visitor's behavior on the website 212 and/or web page 214. In accordance with an embodiment, the on-site web analytic system 232 measures the performance of the web page (or website) in a commercial context. For example, the data collected 234 can be compared against key performance indicators for performance, and used to improve a website or an audience response to marketing campaign.

The data collected 234 is gathered by the web page analytics system 232 via a component (“tag”) 216 in the page. For example, the component or tag 216 can be written in JavaScript, though Java, Flash, etc. The JavaScript or code is added to the website by the website owner for each and every page of the website. The code runs in the client browser when the client browses the page (if JavaScript is enabled in the browser) and collects visitor data 216 and sends it to the data collection server 230 as part of a request for a web beacon.

The component or page tag 214 can be JQuery and AJAX also used in conjunction with a server-side scripting language (such as PHP) to manipulate and (usually) store it in a database, basically enabling complete control over how the data is represented. The script may have access to additional information on the web client or on the user, not sent in the query, such as visitors' screen sizes and the price of the goods they purchased. Page tagging can report on events which do not involve a request to the web server, such as interactions within Flash movies, partial form completion, mouse events such as onClick, onMouseOver, onFocus, onBlur etc. The web page analytics system 232 manages the process of assigning cookies to visitors. However with logfile analysis, the server has to be configured to do so.

As shown in FIG. 2, the client or client device 220 (e.g., having an IP address of 175.1.5.17) visits the website 212 and the component or page tag 214 is forwarded to the on-site web analytics system 232, which receives the data from the web page 212 and measures a visitor's behavior on the website 212. In accordance with an embodiment, the on-site web analytic system 232 can measure the performance of the web page (or website) 212 in a commercial context by comparing the data obtained against key performance indicators, which can then be used to improve a website 212 and/or marketing approaches for the owner of the website 212. The gathering of the information from the website 212 by the on-site web analytics system 232 can be referred to as tag management.

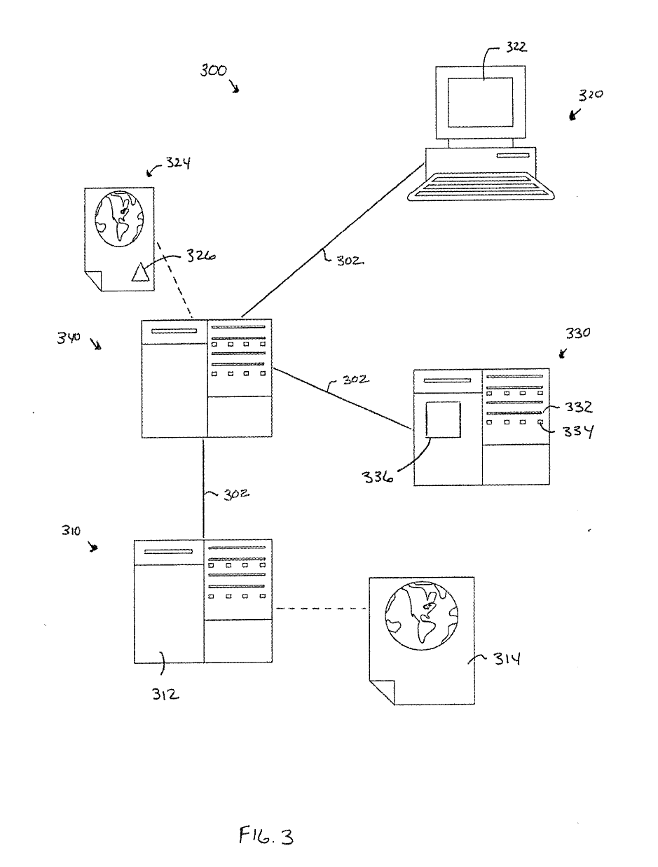

FIG. 3 is an illustration of a network system for web analytics 300 in accordance with an exemplary embodiment. As shown in FIG. 3, the system 300 includes a web server 310, which hosts one or more websites 312, each of the one or more websites 312 hosting at least one web page 314, a client or client device 320 having a web browser 322, a data collection system 330 in the form of a proxy web analytic system 332 and a proxy 340. In accordance with an exemplary embodiment, the at least one website 312 having at least one web page 314 is accessed by the client or client device 320 through the proxy 340 via a network connection 302.

In accordance with an exemplary embodiment, the client or client device 320 is a computing device, for example, a computer, PDA, cell phone, any devices with an embedded CPU/software, and/or another node or cluster, which can include application running on a computing device, and a set of resources (files, services, devices, etc.), which can be identified with an individual name and/or IP address and port number.

The website 312 having one or more web pages 314 is hosted on at least one web server 310. For example, the website 312 can be hosted by a plurality of locations and/or web servers 310. The web pages 314 hosted on the at least one web server 310 can be in an HTML formal, an XHTML format, and/or other known formats, and each of the one or more web pages 314 can provide navigation to other web pages via hypertext links. In addition, web server 310 can subsume other resources such as style sheets, scripts and images into their final presentation. In accordance with an embodiment, the web server 310 does not require and/or include a component or page tags for tracking website use in the web pages 314.

In accordance with an exemplary embodiment, the proxy 340 is configured to insert page tag(s) 326 into the web pages 314 (e.g., HTML pages), which is then delivered to the client or client device 320. The page tag(s) 326 are inserted into the web page 314 by the proxy 340 forming a modified web page 324 having a component or page tag 326 are then tracked by the proxy 340 and delivered to the date collection system 330 and the proxy web analytics manager 332. In accordance with an exemplary embodiment, the website 312 and the one or more web pages 314 can be hosted at one or more locations (e.g., different servers) without requiring each of websites 312 and/or web pages 314 having web tags for each and every server, which hosts the website 312 and/or web pages 314.

In accordance with an exemplary embodiment, the proxy 340 can be a networking device, an application delivery controller, an HTTP appliance, a TCP appliance, a web server, a web proxy, and/or a load balancer. For example, if the proxy 340 is an application delivery controller or gateway, the proxy 340 preferably includes at least one proxy server having a network and policy management center preferably in the form of an AAA server (i.e., authentication and authorization server (e.g. LAP, RADIUS etc.)). However, other suitable network and policy management devices including firewalls, encryption, including symmetric-key encryption and/or public-key encryption, IPSec (IP security) and/or an AAA server can be used.

In accordance with an exemplary embodiment, the proxy web analytics manager 332 is configured to track visitors from all referrers, including search engines, display advertising, pay-per-click networks, e-mail marketing and digital collateral such as links within PDF documents based on receipt of the page tag(s) as provided by the proxy 340. Alternatively, the proxy web analytics manager 332 can be configured to track visitors from only specific clients and/or web clients depending on one or more parameters specified by the customer.

In accordance with an exemplary embodiment, for example, the data collection system 330 having the proxy web analytics manager 332 is configured to process HTTP headers, and parse HTML pages. The proxy web analytics manager 332 can also provide for automated tag management, real time data management, for example, specific company tags (e.g., Array Networks) and third-party tags. In accordance with an exemplary embodiment, the proxy web analytics manager 332 includes a graphical user interface 336, which provides assists to an administrator for insertion of page tags into the one or more web pages 312 when delivered to the web browser 322 from the proxy 340.

In accordance with an exemplary embodiment, the web analytic manager 332 can provide the website owner with savings associated with resources and money since the control of the website is in control of the business or marketing personal rather than the IT department. For example, by designing the proxy 340 to be user friendly, the insertion of the web tags 326 can be performed by business or marketing department personnel rather than IT specialist for the insertion of the page tags into each of the desired web pages 314.

The use of a proxy 340 for web analytics can also produce a system 300, which provides increased flexibility and performance over the traditional web analytics since web tags (or components) do not need to be placed in each and every website 312 and/or web page 314 for each host site 310. In addition, by controlling the placement of the web tag, the system 300 can have improved accuracy and efficiency in tracking visits to each of the websites and/or web pages of the customer. For example, the web tag 326 can be designed to track specific activities such as IP address, type of browser, network bandwidth, and/or type of client or client device, for example, mobile device or desktop. Since the proxy 340 is in line with the browser 322, the web tags 326 can be designed to take into consideration the type of request and any conditions associated with the request.

In addition, the analytic web manager 332 can be implemented by the customer without the necessity of an outside vendor and/or service. Furthermore, the use of the proxy 340 can also provide increased security measures for the detection of fraudulent transactions, hacking of websites, and other fraudulent and/or inappropriate uses of websites and data and content hosted therein

In accordance with another exemplary embodiment, the proxy 340 includes a copy (or cache) of each of the one or more web pages 314 hosted by the web server (or web servers) 310, which allows the customer to provide the proxy 340 with instructions in connection with the insertion or pasting of web page tags within the requested web pages 314. In accordance with an exemplary embodiment, for example, the proxy 340 has a cached copy of each of the one or more web pages 314 of the customer, which is hosted by the web server 310.

Additional benefits by implementing a proxy 340 for website owners or service providers can include monetary and resource savings, additional services for customers, real-time tag management, no JavaScript, customers can experiment with different tags, and convenience and control for customers.

In accordance with an exemplary embodiment, the proxy 340 can be application delivery controllers and/or a virtual private network device, which provides a secure connection between a client or client device 320 and a web server 310 over a communication network 302 such as the Internet, and/or an Intranet. In a secure connection between the client 320 and the web server 310, a tunneling protocol can be used, which encapsulates one protocol or session inside another. The tunneling protocol preferably includes a suitable protocol, wherein the transmission of data intended for use only within a private, usually corporate network through a public network in such a way that the routing nodes in the public network are unaware that the transmission is part of a private network.

It can be appreciated that the tunneling is preferably performed by encapsulating the private network data and protocol information within the public network transmission units so that the private network protocol information appears to the public network as data. The tunnel can be established using a secure protocol, such as SSL (secure sockets layer) or TLS (transport layer security), which provide secure communications on the Internet for such things as e-mail, Internet faxing, and other data transfers. SSL provides endpoint authentication and communications privacy over the Internet using cryptography.

For example, an application delivery controller (ADC) is a network device (or networking device) that can be used to perform tasks done by websites in an effort to remove load from the web servers themselves. The application delivery controller usually sits between the firewall/router and the web farm. The application delivery controller can also perform load balancing, content manipulation, advanced routing strategies as well as highly configurable server health monitoring. In addition, application delivery controllers also offer features like compression, cache, connection multiplexing, application layer security, SSL offload, content switching combined with basic server load balancing.

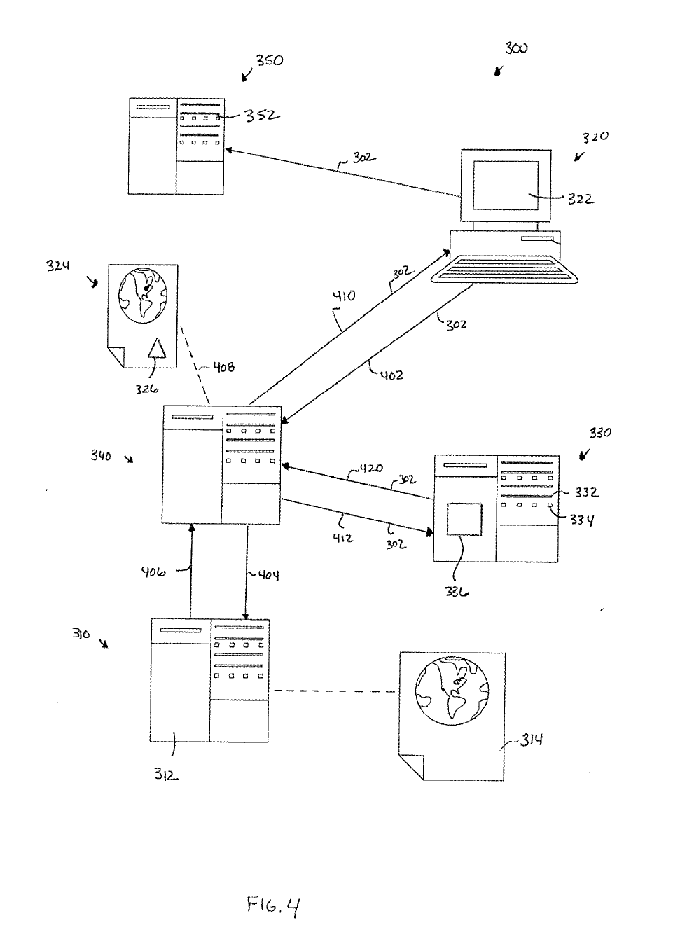

FIG. 4 is an illustration of a network system 300 for web analytics in accordance with another exemplary embodiment. As shown in FIG. 4, the network system 300 includes a web server 310, which hosts one or more websites 312, each of the one or more websites having at least one web page 314, a client or client device 320 having a web browser 322, a data collection system 330 having an analytic web analysis system 332, and a proxy 340.

In accordance with an exemplary embodiment, in step 402, the web browser 322 on the client or client device 320 sends a request to the proxy 340 for a web page 314 hosted by the web server 310. In step 404, the request from the browser 322 is forward from the proxy 340 to the web server 310, which retrieves the website 312 and the requested web page 314 hosted by the web server 310. In step 406, the web server 310 sends a response to the proxy 340 containing the data requested by the web browser 322. In accordance with an exemplary embodiment, the web page 312 is in the form of a HTML page. In step 408, the proxy 340 inserts a component or page tag 326 into the HTML page forming a modified web page 324 having one or more components or page tags 326. For example, in accordance with an exemplary embodiment, the component or page tag 326 is a JavaScript tag.

In step 410, the web browser 322 receives the modified web page 326 and the based on the user's interactions, the component or page tag 326 runs in the client browser 322 when the client browses the page, if JavaScript is enabled in the browser, the JavaScript is executed with within the webpage 326 as delivered to the web browser 322. In step 412, the proxy 340 executes the JavaScript within the web page 324 and sends a response to the data collection system 330, which corresponds to the action of the web browser 322, which can be used to produce reports on web traffic for the website 312 and/or web page 314.

In accordance with an exemplary embodiment, the data collection system 330 includes the web proxy analytic manager 332, which tracks the actions of each of the users of the website or web page 312. The data collection system 330 can collection data from search engines, display advertising, pay-per-click networks, e-mail marketing and digital collateral such as links within PDF documents from the web server 322.

In accordance with an exemplary embodiment, in step 420, an administrator via the graphical user interface 336 and/or other means of programming the proxy 340, can insert page tags 326 into the one or more web pages 314 cached within the proxy 340, which are images of the websites 312 and web pages 314 hosted by the web server 310. In accordance with an exemplary embodiment the proxy 340 can be configured by the web analytic manager 332 to insert the one or more page tags 326 into the web pages 314, wherein the one or more page tags 326 can be configured to generate different reports, requests, conditions, classification of browsers, and the like.

In accordance with an alternative embodiment, the data collection system 330 can be hosted and/or a part of the proxy 340. It can be appreciated that if the data collection system 330 is hosted on the proxy 340, to avoid violating do not track policies associated with certain web browsers 322.

In accordance with an exemplary embodiment, the proxy 340 can be configure to insert different tag(s) based on client IP address, location of device, type of device, network, HTTP header(s) and/or request content. Alternatively, the proxy 340 can be configured to not insert tag(s) based on client IP address, location of device, type of device, network, HTTP header(s) and/or request content. In accordance with another exemplary embodiment, the proxy 340 can be configured to remove tag(s) based on client IP address, location of device, type of device, network, HTTP header(s) and/or request content.

In accordance with another exemplary embodiment as shown in FIG. 4, the system 300 includes an analytics server 350, which receives analytics data directly from the client 320 without going through the proxy 340. The analytics server 350 can collect the analytics data 352 from client 320 via a proxy (not shown) located within the client 320, which transmits the data 352 to via an internet connection 302 to the server 350. In accordance with an exemplary embodiment, the data 352 can include data related to web traffic for websites and/or a web pages accessed by the client 320.

In accordance with another exemplary embodiment, a non-transitory computer readable medium containing a computer program having computer readable code embodied therein for tracking visits to a web page using a proxy, comprising: receiving a request from a web browser on a proxy for a web page hosted on a web server; sending the request for the web page from the proxy to the web server; receiving the web page from the web server on the proxy; inserting one or more web page tags into the web page to generate a modified web page, wherein the one or more web page tags generate data about traffic to the web page; forwarding the modified web page to the web browser with the one or more web page tags embedded therein; executing the one or more web page tags within the modified web page; and sending data from the executed one or more web page tags a data collection system.

The method and system for tracking visits to a web page using a proxy as disclosed herein may be implemented using hardware, software or a combination thereof. In addition the method and system for tracking visits to a web page using a proxy as disclosed herein may be implemented in one or more computer systems or other processing systems, or partially performed in processing systems such as personal digit assistants (PDAs). In yet another embodiment, the invention is implemented using a combination of both hardware and software.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for tracking visits to a web page using a proxy, comprising:
receiving a request from a web browser on a proxy for a web page hosted on a web server;
sending the request for the web page from the proxy to the web server;
receiving the web page from the web server on the proxy;
inserting one or more web page tags into the web page to generate a modified web page, wherein the one or more web page tags generate data about traffic to the web page;
forwarding the modified web page to the web browser with the one or more web page tags embedded therein;
executing the one or more web page tags within the modified web page; and
sending data from the executed one or more web page tags a data collection system.

2. The method of claim 1, comprising:
hosting the data collection system on the proxy.

3. The method of claim 1, comprising:
analyzing the data to generate one or more reports on visitations to the web page.

4. The method of claim 1, comprising:
managing the embedding of the one or more web page tags into the modified web page using a proxy web analytics manager.

5. The method of claim 4, comprising:
caching a copy of the web page hosted on the web server; and
inserting the one or more web page tags into the copy of the web page hosted on the proxy.

6. The method of claim 5, comprising:
providing the proxy web analytics manager with a graphical user interface to assist with the insertion of the one or more web page tags into the copy of the web page hosted on the proxy.

7. The method of claim 1, wherein the web page tag is a JavaScript.

8. The method of claim 1, wherein the web page is an HTML page.

9. The method of claim 1, comprising:
configuring the proxy to insert different tag(s) based on client IP address, location of device, type of device, network, HTTP header(s) and/or request content.

10. The method of claim 1, comprising:
configuring the proxy to remove tag(s) based on client IP address, location of device, type of device, network, HTTP header(s) and/or request content.

11. A system for tracking visits to a web page hosted by a web server, comprising:
a proxy configured to:
receive a request from a web browser for a web page hosted on a web server;
send the request for the web page to the web server;
receive the web page from the web server;
insert one or more web page tags into the web page to generate a modified web page, wherein the one or more web page tags generate data about traffic to the web page;
forward the modified web page to the web browser with the one or more web page tags embedded therein; and
send data from execution of one or more web page tags by the web browser to a data collection system.

12. The system of claim 11, comprising:
a data collection system configured to:
receive data from the proxy; and
analyze the data to generate one or more reports on visitations to the web page.

13. The system of claim 11, wherein the proxy caches a copy of the web page hosted on the web server.

14. The system of claim 13, comprising:
a web analytics manager configured to:
insert the one or more web page tags into the copy of the web page hosted on the proxy.

15. The system of claim 14, comprising:
providing the proxy web analytics manager with a graphical user interface to assist with the insertion of the one or more web page tags into the copy of the web page hosted on the proxy.

16. The system of claim 11, comprising:
configuring the proxy to insert different tag(s) based on client IP address, location of device, type of device, network, HTTP header(s) and/or request content.

17. The system of claim 11, comprising:
configuring the proxy to remove tag(s) based on client IP address, location of device, type of device, network, HTTP header(s) and/or request content.

18. A non-transitory computer-readable storage medium comprising computer-executable instructions that, in response to execution, cause a computing system to perform operations for tracking visits to a web page using a proxy, comprising:
receiving a request from a web browser on a proxy for a web page hosted on a web server;
sending the request for the web page from the proxy to the web server;
receiving the web page from the web server on the proxy;
inserting one or more web page tags into the web page to generate a modified web page, wherein the one or more web page tags generate data about traffic to the web page;
forwarding the modified web page to the web browser with the one or more web page tags embedded therein;
executing the one or more web page tags within the modified web page; and
sending data from the executed one or more web page tags a data collection system.

19. The storage medium of claim 18, comprising:
hosting the data collection system on the proxy.

20. The storage medium of claim 18, comprising:
analyzing the data to generate one or more reports on visitations to the web page.

21. The storage medium of claim 18, comprising:
managing the embedding of the one or more web page tags into the modified web page using a proxy web analytics manager.

22. The storage medium of claim 21, comprising:
caching a copy of the web page hosted on the web server; and
inserting the one or more web page tags into the copy of the web page hosted on the proxy.

23. The storage medium of claim 22, comprising:
providing the proxy web analytics manager with a graphical user interface to assist with the insertion of the one or more web page tags into the copy of the web page hosted on the proxy.

24. The storage medium of claim 18, comprising:
configuring the proxy to insert different tag(s) based on client IP address, location of device, type of device, network, HTTP header(s) and/or request content.

25. The storage medium of claim 18, comprising:
configuring the proxy to remove tag(s) based on client IP address, location of device, type of device, network, HTTP header(s) and/or request content.
